(19) United States
(12) Patent Application Publication
(10) Pub. No.: US 2016/0031617 A1
(43) Pub. Date: Feb. 4, 2016

(54) PRESSURE VENT VALVE

(71) Applicant: ION GEOPHYSICAL CORPORATION, Houston, TX (US)

(72) Inventors: Eddie Joseph FAUCHEAUX, Jr., Waggaman, LA (US); Addison Paul MOTCH, Metairie, LA (US)

(21) Appl. No.: 14/774,600

(22) PCT Filed: Mar. 13, 2014
(86) PCT No.: PCT/US2014/026296

§ 371 Date: Sep. 10, 2015

Related U.S. Application Data
(60) Provisional application No. 61/778,829, filed on Mar. 13, 2013.

(51) Int. Cl. B65D 51/16; F16K 31/60; F16K 24/04

(52) U.S. Cl. CPC B65D 51/1644; F16K 24/04; F16K 31/602

(57) ABSTRACT

Embodiments of the invention are generally directed to a vent valve that may be used to seal a container. The vent valve may control a vent path connecting an interior of the container to the external environment. The vent valve may be kept open during installation and extraction of components in the container, thereby preventing an imbalance between the pressure inside the container and the external environment.

### CROSS REFERENCE TO RELATED APPLICATIONS

This application claims priority to and the benefit of PCT application number PCT/US2014/026296, entitled “Pressure Vent Valve,” which was filed on Mar. 13, 2014, and also claims priority to and the benefit of U.S. provisional application No. 61/778,829, entitled “Water Tight Battery End Cap with Automatic Pressure/Vacuum Vent Valve Release Port,” which was filed on Mar. 13, 2013, each of which is hereby incorporated by reference in its entirety for all purposes.

### FIELD

This disclosure relates generally to systems and apparatus for sealing a container.

### BACKGROUND

Petrochemical products such as oil and gas are ubiquitous in society and can be found in everything from gasoline to children's toys. Because of this, the demand for oil and gas remains high. In order to meet this high demand, it is important to locate oil and gas reserves in the Earth. Scientists and engineers conduct “surveys” utilizing, among other things, seismic and other wave exploration techniques to find oil and gas reservoirs within the Earth. These seismic exploration techniques often include controlling the emission of seismic energy into the Earth with a seismic source of energy (e.g., dynamite, air guns, vibrators, etc.), and monitoring the Earth's response to the seismic source with one or more receivers in order to create an image of the subsurface of the Earth. By observing the reflected seismic wave detected by the receiver(s) during the survey, the geophysical data pertaining to reflected signals may be acquired and these signals may be used to form an image of the Earth near the survey location.

Each receiver may include, for example, a pressure sensor and/or a particle motion sensor in proximity to one another. The pressure sensor may be, for example, a hydrophone that records scalar pressure measurements of a seismic wavefield. The particle motion sensor may be, for example, a three-component geophone that records vectorial velocity measurements of the seismic wavefield. By observing the reflected seismic wavefield detected by the receiver(s) during the survey, the geophysical data pertaining to reflected signals may be acquired and these signals may be used to form an image indicating the composition of the Earth near the survey location.

Marine seismic surveys generally involve towing one or more streamer cables comprising a plurality of receivers with a seismic vessel. One or more devices, for example, depth control devices and/or lateral position control devices may be attached to the streamer cables to position the streamers in a desired configuration during the survey. Devices attached to the streamer may be exposed to surrounding water, therefore, electronics and other delicate components may be enclosed in sealed, water tight, and hydro dynamically shaped containers.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

FIG. 1 illustrates a seismic survey according to an embodiment of the invention.

FIG. 2 illustrates an exemplary device for use in an underwater seismic survey, according to an embodiment of the invention.

FIG. 3 illustrates another exemplary device for use in an underwater seismic survey, according to an embodiment of the invention.

FIGS. 4A-4C illustrate sealing of a container according to the prior art.

FIGS. 5A-5B illustrate sealing of a container according to an embodiment of the invention.

FIGS. 6A-6B illustrate a vent valve according to an embodiment of the invention.

FIGS. 7A-7B illustrate use of an extraction tool according to an embodiment of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

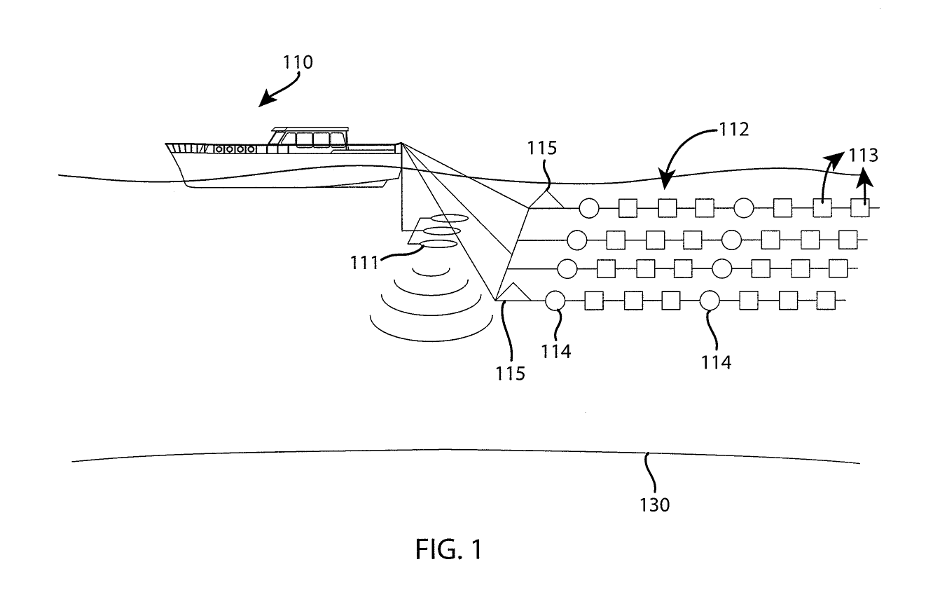

FIG. 1 illustrates an exemplary seismic survey according to an embodiment of the invention. As illustrated, a seismic vessel 110 may tow one or more seismic sources 111 and one or more streamer cables 112. Each streamer cable 112 may include a plurality of seismic sensors 113. Exemplary seismic sensors include any one or combinations of hydrophones, geophones, particle motion sensors such as accelerometers, and the like. In one embodiment, one or more devices 114 may be coupled to one or more of the cables 112. In one embodiment, the devices 114 may be steering devices configured to control depth and/or lateral position of a respective cable such that an acceptable shape of the streamer cable array is maintained. In alternative embodiments, the devices 114 may include any variety of devices including seismic sensor systems, seismic source systems, or the like. In general, the devices 114 may be any type of device that includes components that may be sealed in a housing in a water tight manner to prevent damage to the components within the housing. In one embodiment, the streamer cable array may also be equipped with one or more diverters (or paravanes) 115. The diverters 115 may cause the streamer cable array to spread when towed such that an acceptable distance is maintained between the streamer cables 112.

The seismic source 111 may be an air gun configured to release a blast of compressed air into the water column towards the seabed 130. A blast of compressed air from the air gun 111 generates seismic waves which may travel down towards the seabed 130, and penetrate and/or reflect from sub-seabed surfaces. The reflections from the sub-surfaces may be recorded by seismic sensors 113 as seismic data. The seismic data acquired via the seismic sensors 113 may be processed to develop an image of the sub-surface layers. These images may be analyzed by geologists to identify areas likely to include hydrocarbons or other substances of interest.

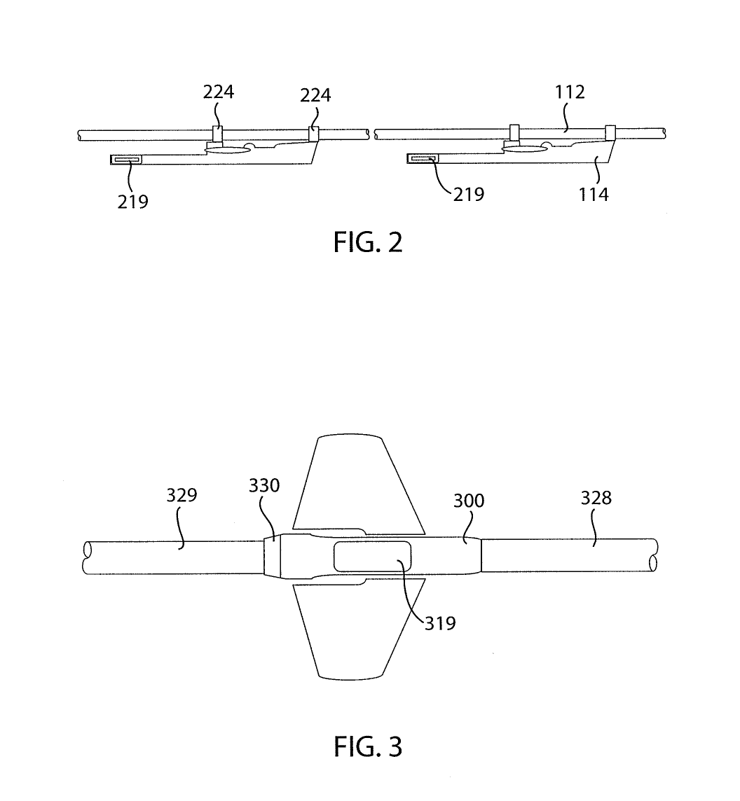

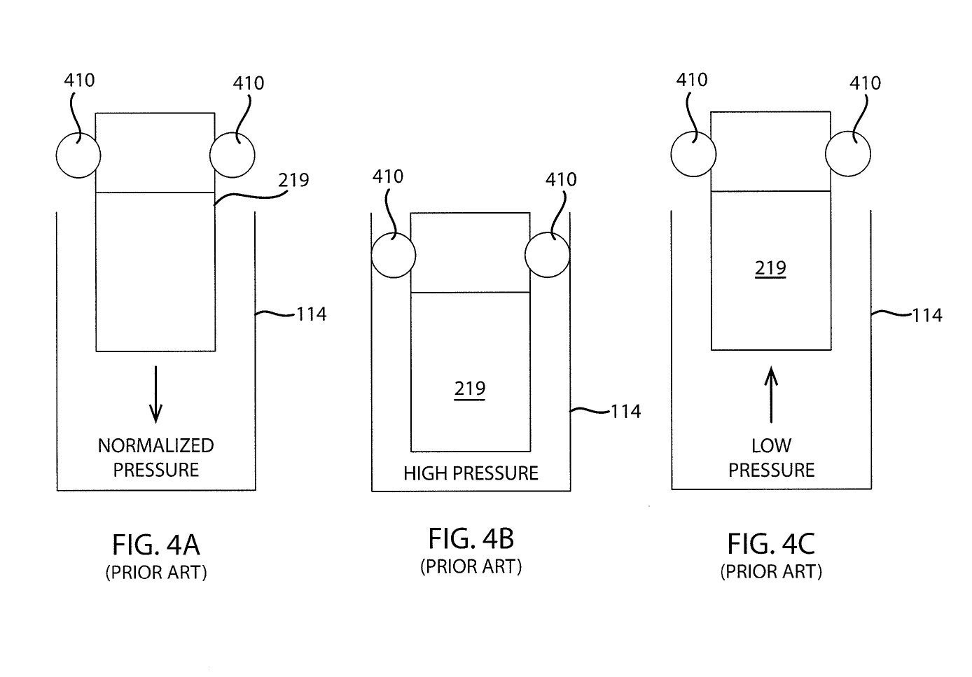

FIG. 2 illustrates a more detailed view of a device 114 according to an embodiment of the invention. The device 114 can be mounted within a streamer cable 112. In one embodiment the device 114 may be rotatably attached to the streamer by collars 224. As shown in FIG. 2, the device 114 may include component 219. In one embodiment, the component 219 may be an electronic component, for example, an electric circuit board, a seismic sensor, an accelerometer, geophone, etc., or any combination thereof. More generally, the component 219 may be any components that may be damaged by exposure to the environment outside the device 114, e.g., sea water. FIG. 3 illustrates a specific embodiment of the device 114 as a cable-positioning device 300 connected in line between fore and aft streamer sections 328, 329 that can house the sensor portion of a seismic system 319. The seismic system 319 is an example of the component 219 of FIG. 2. Further shown in FIG. 3 is an end cap 330 of the cable positioning device 300, which may be used to seal the device 300 after insertion of the system 319.

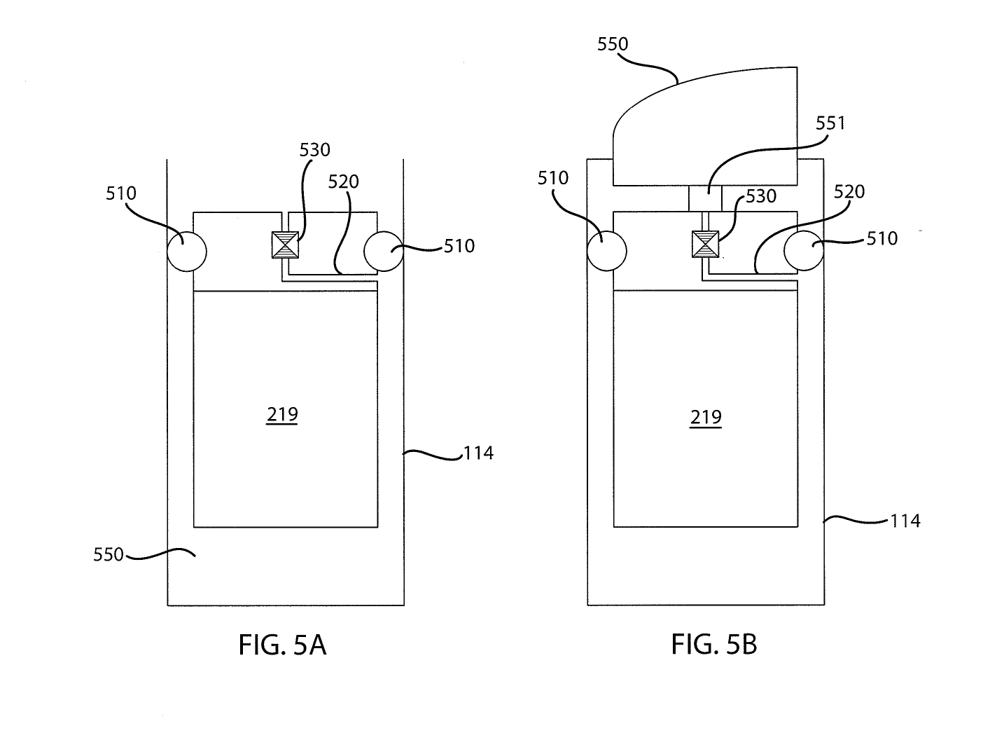

FIGS. 4A-C illustrate the prior art process for inserting a components 219 into a container/device housing 114. As shown in FIG. 4A, an o-ring 410 may be used to seal the component 219 into the container 114 in a water tight and/or air tight manner. Before engagement of the o-ring with the container 114, the pressure in the container 114 may be a normalized environmental pressure, as shown in FIG. 4A. However, insertion of the device 219 into the container 114 may compress the air in the container 114, thereby increasing the pressure therein as shown in FIG. 4B. The increased pressure in the container 114 may not be desirable as it may damage the components, or otherwise adversely affect operation of the component 219. Furthermore, the increasing pressure in the container may make it increasingly difficult to push the device 219 further into the container into a desirable position. Conversely, during removal of the device 219 from the container 114, a substantially low pressure or vacuum may be created in the container 114, thereby creating a suction force that may make it difficult to extract the device 219, as shown in FIG. 4C.

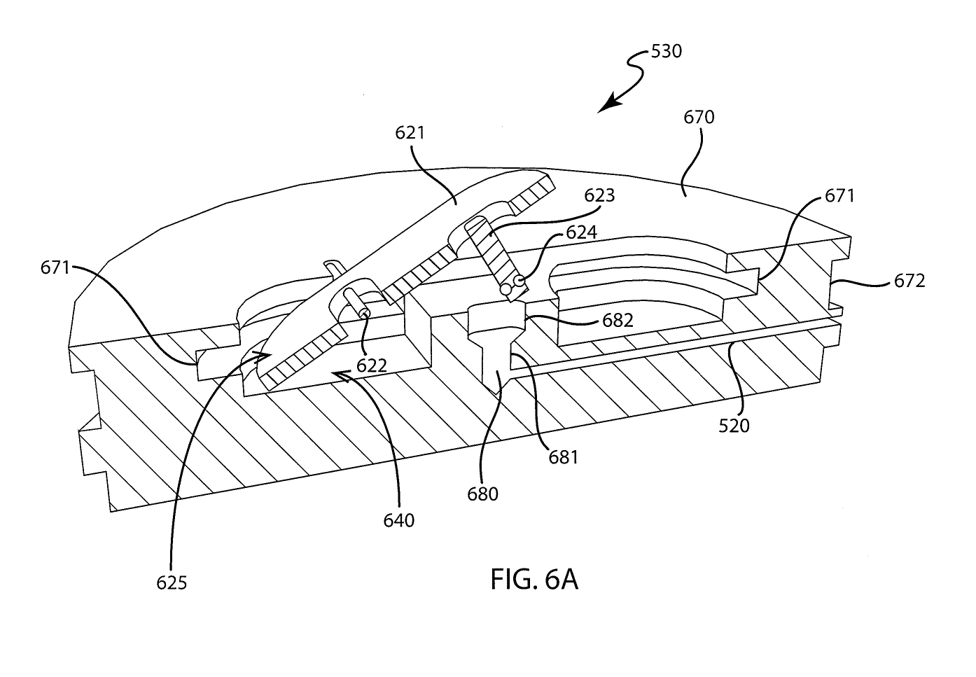

Embodiments of the invention provide a vent valve configured to equalize or maintain the internal pressure in the container 114 prior to sealing the container. FIGS. 5A and 5B illustrate a component 219 in a container 114 according to an embodiment of the invention. As illustrated in FIG. 5A, a vent path 520 may connect an internal area 550 of the container 114 to the outside of the container. A vent valve 530 may be provided on the vent path 520. During insertion of the device 219 into the container 114, the vent valve 530 may be open, thereby allowing airflow between the external environment and the inside of the container and preventing pressure from building up in the area 550. Thereafter, when the device 219 is positioned at a desired location in the container 114, the vent valve may be closed, thereby sealing the container within the area 550 by means of, at least, the o-rings 510. By keeping the vent valve open during insertion the pressure in the area 550 may be maintained at a level substantially equal to the pressure outside the container at the time of sealing. Embodiments of the invention are not limited to the use of o-rings for sealing the container. In alternative embodiments, any other reasonable mechanical seal or gasket may be used in place of the o-rings 510.

In one embodiment of the invention, an automatic sealing mechanism may be employed to close the valve 530 and seal the device 219 within the container 114. For example, a cap 550 may be installed on the container, whereby insertion of the cap causes the valve 530 to become closed. For example, in FIG. 5B, a protruding member 551 of the cap 550 may engage with the valve 530 upon installation of the cap, whereby the engagement causes the valve 530 to become closed.

While embodiments of the invention described herein illustrate a device 219 coupled to the o-ring 510, vent valve 530, and vent path 520, in alternative embodiments, the device 219 may be separately placed in the container 114. Thereafter a separate device comprising the vent path, vent valve, and o-ring may be inserted to seal the device in the container. In one embodiment, the vent path, vent valve, and o-ring may be a part of the cap 550.

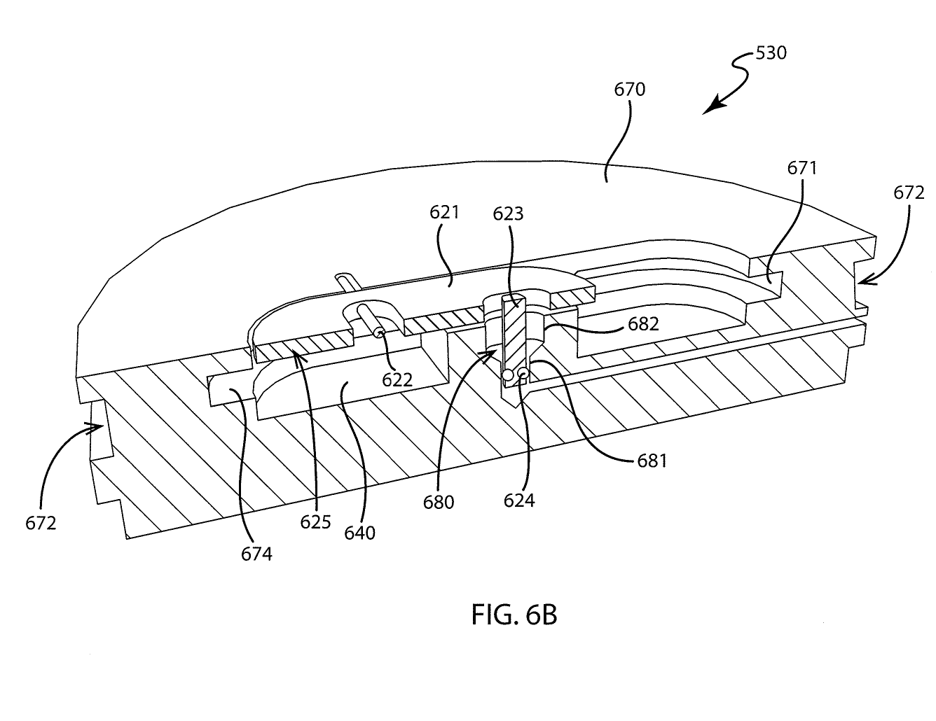

FIGS. 6A and 6B illustrate a more detailed view of a vent valve 530 according to an embodiment of the invention. As shown the vent valve 530 may include a lever 621 configured to rotate about a pivot point 622 to move a sealing member 623. The lever 621 may be configured to position the sealing member in at least a first position (or open position) shown in FIG. 6A and a second position (closed or sealed position) shown in FIG. 6B. The lever 621 may be attached to a body 670 comprising the pivot point 622. As shown in FIG. 6A, the body may include a recessed area 640 for receiving a first end 625 of the lever 621. The body may also include a recessed area 680 for receiving the sealing member 623. As further shown the recessed area 680 may include a first section 681 having a first width and a second area 682 having a second width, wherein the first width is less than the second width.

As illustrated in FIG. 6A, in one embodiment the lever 621 may be configured to lift the sealing member 623 at least partially out of the recessed area 680 to place the vent valve in the open position. In the open position, the sealing member may be substantially removed from the section 681 of the recessed area 680 such that vent path 520 is open. I.e., because the width of the section 682 is greater than the width of the section 681, the o-ring 624 may not engage with the walls of section 682 when in the open position, thereby opening the vent path 520. As shown in FIG. 6B, the sealing member 623 may include an o-ring 624, which may engage with sidewalls of the section 681 when the valve is in the closed position. While an o-ring 624 is illustrated in FIGS. 6A and 6B, in alternative embodiments, a gasket or any other type of mechanical seal may be used in place of the o-ring 624.

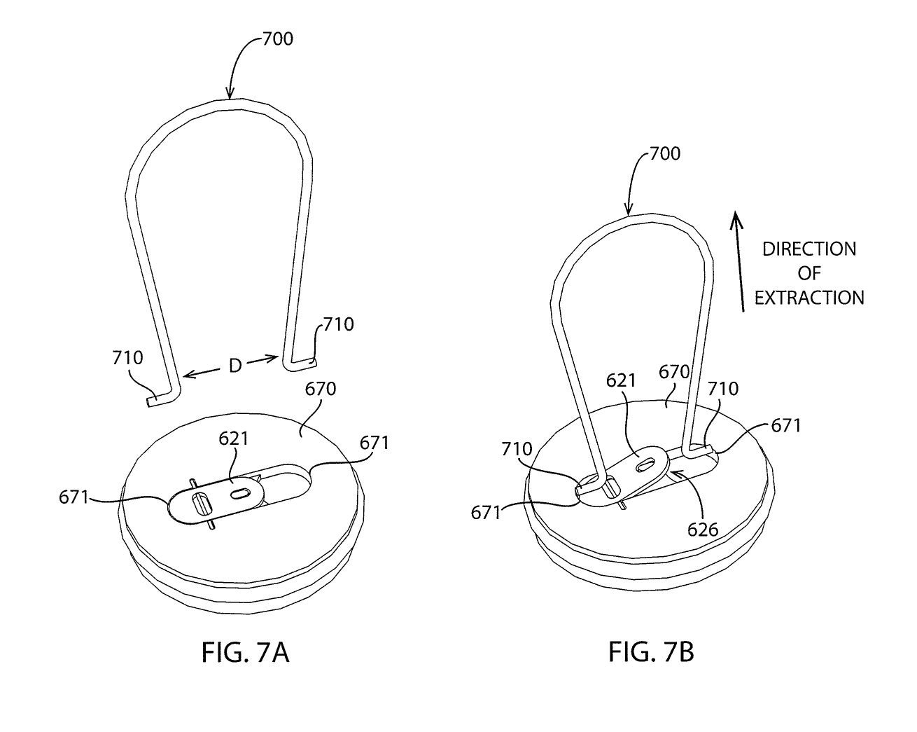

As further illustrated in FIGS. 6A and 6B, the body 670 may also include recessed sections 671 and 672. The recessed sections 672 may be configured to receive an o-ring, e.g., the o-ring 510 of FIGS. 5A-B, configured to seal a container. The recessed portions 671 may be configured to receive prongs of an extraction tool. FIGS. 7A and 7B illustrate the use of an extraction tool 700 according to an embodiment of the invention. The extraction tool may include prongs 710 that may be spring loaded or otherwise biased to maintain a minimum distance D, as shown in FIG. 7A. During extraction, the prongs 710 may be pulled closer together, and pressed down into the recessed sections 671 of the body 670, as shown in FIG. 7B. In one embodiment of the invention, inserting a prong 710 into the recessed section 671 may cause the lever 621 to change from a sealed or closed position to an open position, as shown in FIGS. 7A-B. Furthermore, the engagement of the prongs 710 to the recessed portion 671 may allow extraction of the body 670 (and any attached components) by lifting the extraction tool 700. While the tool 700 is referred to herein as an extraction tool, one skilled in the art will appreciate that the tool 700 may also be used during insertion of the vent valve.

Referring back to the cap 550 of FIG. 5B, in one embodiment, a protruding member 551 of the cap 550 may be configured to change a position of the valve from an open position to a closed position. For example, upon installation of the cap 550, the protruding member 551 may engage with an end 626 (see FIG. 7B) of the valve, thereby causing the valve to change position. In alternative embodiment, the protruding member 551 may be omitted, and any predefined surface of the cap 550 may be configured to engage with and close the vent upon installation of the cap.

While embodiments of the invention are described herein with reference to marine seismic surveying operations, one skilled in the art will recognize that the sealing mechanism disclosed herein can be used in a wide variety of industries and applications. In general, embodiments of the invention may be utilized for sealing any type of container wherein the inside environment of the container needs to be sealed from the external environment, whether in water, air, or other substances. While the foregoing is directed to embodiments of the present invention, other and further embodiments of the invention may be devised without departing from the basic scope thereof, and the scope thereof is determined by the claims that follow.

1. A vent valve, comprising:
a vent path;
a lever; and
a sealing member coupled to a first end of the lever,
wherein the lever is configured to position the sealing member in at least a first position and a second position, wherein, in the first position, the sealing member is configured to seal the vent path, and wherein, in the second position, the sealing member is configured to open the vent path.

2. The vent valve of claim 1, further comprising a first recessed area for receiving a second end of the lever.

3. The vent valve of claim 1, further comprising at least one second recessed area for engaging an insertion tool configured to position the vent valve.

4. The vent valve of claim 3, wherein engaging the insertion tool with the at least one second recessed area causes the lever to position the sealing member in the second position.

5. The vent valve of claim 1, wherein the sealing member comprises an o-ring.

6. The vent valve of claim 1, wherein the sealing member is configured to be positioned in a third recessed area of the vent valve, wherein the third recessed area is connected to the vent path.

7. A system, comprising:
a container,
a component placed in the container, and
a vent valve, the vent valve comprising:
a vent path;
a lever; and
a sealing member coupled to a first end of the lever,
wherein the lever is configured to position the sealing member in at least a first position and a second position, wherein, in the first position, the sealing member is configured to seal the vent path thereby sealing the component in the container, and
wherein, in the second position, the sealing member is configured to open the vent path, thereby unsealing the container.

8. The system of claim 7, wherein the vent valve comprises a first recessed area for receiving a second end of the lever.

9. The system of claim 7, further comprising an extraction tool comprising at least one prong, and wherein the vent valve comprises at least one second recessed area for engaging with the prong during extraction.

10. The system of claim 9, wherein engaging the prong with the second recessed area causes the lever to switch from the first position to the second position.

12. The system of claim 7, wherein the sealing member comprises an o-ring.

13. The system of claim 7, wherein the sealing member is configured to be positioned in a third recessed area of the vent valve, wherein the third recessed area is connected to the vent path.

14. The system of claim 7, further comprising a cap configured to close the container, wherein a surface of the cap is configured to engage with the vent valve.

15. The system of claim 14, wherein the engaging of the cap with the vent valve causes the lever to be positioned in the first position.

16. The system of claim 7, wherein the vent valve is coupled to the component.
